(19) United States
(12) Patent Application Publication
(10) Pub. No.: US 2013/0020342 A1
(43) Pub. Date: Jan. 24, 2013

(54) Storing, Transporting and Dispensing Apparatus, and Method of Use Thereof

(71) Applicant: Carlos Cardoso, Cumming, GA (US)

(72) Inventor: Carlos Cardoso, Cumming, GA (US)

(73) Assignee: Global Marketing Products, Inc.

(21) Appl. No.: 13/185,731

(22) Filed: Jul. 19, 2011

(51) Int. Cl. B65G 59/02; B65D 83/00

(52) U.S. Cl. 221/1; 221/282; 221/251; 221/199

(57) ABSTRACT

An apparatus for storing, transporting and dispensing balls, specifically golf balls. The apparatus has a tube with a spring at one end to force balls towards the second end, the second end having an opening and a restraint to keep the golf balls from inadvertently exiting the apparatus. The apparatus further has a cap that is selectively secured to the apparatus over the opening, thereby enclosing the golf balls within the apparatus. In an alternate embodiment, the apparatus is dimensioned to store soda cans, and the apparatus comprises insulating material to keep the soda cans in a temperature-controlled environment.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to storing and transporting objects, and more specifically to storing multiple spherical objects or cylindrical objects in a transportable tube.

2. Description of Related Art

Carrying and dispensing multiple balls or soda cans has long been a difficult proposition. To address this issue, initially a tube was utilized, the tube having a spring to push the golf balls towards an end having a bendable opening that the balls could be forced through. The problem with this approach was that the constant bending of the opening often resulted in a piece breaking.

Another approach was to utilize a carryable short tube that could hold one ball on each end. Another approach was to utilize a slightly longer tube that could hold three balls. A problem with both of these approaches is that so few balls fit in the tube.

Still another approach was to utilize an even longer tube that could hold four or more balls, the tube having openings on either end. A problem with this approach is that it could be difficult to remove a ball from the tube, or if not properly restrained, the balls would fall out if the tube tipped.

Yet another approach was to utilize a very long tube, with one end of the tube having a container to store golf tees. A problem with this approach is that the golf tee container often interfered with removing balls from the tube.

An approach for storing cans involved utilizing a large cube shaped container. A problem with this approach is that space was wasted by the excess size of the container relative to the size of the cans being stored, as this would make the container unnecessarily bulky.

Therefore, it is readily apparent that there is a need for an apparatus that can store balls or cans, the apparatus being easy to transport, the apparatus having a removable cover to enclose the balls or cans, the apparatus further having an opening to allow water or other liquids to drain, and the apparatus being capable of restraining balls or cans from inadvertently exiting the apparatus.

### BRIEF SUMMARY OF THE INVENTION

Briefly described, in a preferred embodiment, the present invention overcomes the above-mentioned disadvantages and meets the recognized need for such a device by providing an apparatus for storing and transporting balls, specifically golf balls. The apparatus has a tube with a spring at one end and an opening at a second end, the second end having restraining protrusions to keep the golf balls from inadvertently exiting the apparatus. The apparatus also has a cap, the cap being secured to the apparatus via a tether. In an alternate embodiment, the apparatus is made of insulating material and is dimensioned to receive soda cans.

According to its major aspects and broadly stated, the present invention in its preferred form is an apparatus for storing, transporting and dispensing items, the apparatus having a cylindrical tube, a restraining piece and a bottom piece. The cylindrical tube has a top section and a bottom section, the restraining piece is attached to the top section, the top section has a top loop, the bottom piece is attached to the bottom section, and the bottom piece has a bottom loop.

The bottom piece further has a bottom surface and an aperture, and the bottom loop and aperture are disposed on the bottom surface. The apparatus further has a top cap and a tether, and the top cap has a cap loop, and the tether is selectively attached to the restraining loop and the cap loop, and the top cap is dimensioned to be selectively secured over the restraining piece.

The restraining piece further has an inner surface and at least one protrusion, and the protrusion is on the inner surface. The apparatus further has a strap, the strap being secured to the bottom loop and the top loop.

The apparatus also has a spring, and the spring is fixedly secured to the bottom piece, the spring comprising an axis, with the axis being parallel to the cylindrical tube. The restraining piece has an upper terminus, and the upper terminus has a relieved area, the relieved area being dimensioned to allow a user to grippingly secure a golf ball stored in the apparatus, such as, for exemplary purposes only, by use of the user's thumb and fingers.

The top cap is made of a material sufficiently flexible to be deformed into the relieved area, wherein the user can grasp the top cap, pressing in to grippingly secure an object in the apparatus.

Preferably, the cylinder has an inside diameter approximately equal to the diameter of a golf ball. In an alternative embodiment, the apparatus has an outer wall made of temperature insulating material, and the top cap and bottom piece are also made of a temperature insulating material, and the apparatus has an inside diameter approximately equal to the diameter of a soda can.

In use, a user grippingly secures an object in the storing and transporting apparatus, the apparatus having a cylindrical tube, the cylindrical tube having a top section and a bottom section, and the apparatus further having a restraining piece, the restraining piece being fixedly secured to the top section, and the top section having a top loop, and the apparatus further having a bottom piece, the bottom piece being fixedly secured to the bottom section, and the bottom piece having a side loop and a side wall, and the side loop being disposed on the side wall.

A user optionally secures a strap to the top loop and the side loop, and then transports the storing and transporting apparatus via the strap. The user subsequently removes the object from the apparatus, the object being within the restraining piece immediately before it is removed. The bottom piece further has an aperture and a bottom surface, and the aperture is disposed on the bottom surface.

In an alternate embodiment, the apparatus has a cylindrical tube, a restraining piece and a tether, the cylindrical tube having a top section and a bottom section, the restraining piece being secured to the top section, and the restraining piece is fixedly secured to the cylindrical tube via the tether.

The apparatus further has a bottom piece, and the bottom piece has a bottom surface and at least one aperture, the aperture being disposed on the bottom surface. The restraining piece has a restraining protrusion, and the restraining protrusion is on the restraining piece. The cylindrical tube being made of an insulating material, and the apparatus is dimensioned to receive soda cans.

More specifically, the present invention is a storing and transporting apparatus, the storing and transporting apparatus preferably having an inside diameter, a restraining piece, a bottom piece, a spring, a platform, an exterior, a top cap, a tether, a strap and a cylinder, the cylinder having a top section and a bottom section, the top section having a top loop, the spring having a lower spring section, an upper spring section and an axis, and when compressed the spring produces a force.

In a preferred embodiment the bottom piece has a side wall, a side loop, a bottom loop, a bottom surface and aperture. The restraining piece has a restraining loop, a protrusion, an upper terminus, a relieved area, an inner surface and an outer surface, and the top cap has a cap loop.

In a preferred embodiment, the bottom piece is fixedly secured to the bottom section of the cylinder, and the lower spring section of the spring is fixedly secured to the bottom section. The axis of the spring extends between the lower spring section and the upper spring section. The upper spring section is fixedly secured to the platform, and if the spring is compressed, then the spring exerts a force along the axis via the platform. The platform is preferably dimensioned approximately equal to the inside diameter of the cylinder. In a preferred embodiment, the strap is secured to the top loop and the side loop. Alternatively, the strap is secured to the top loop and the bottom loop. In another alternate embodiment, the strap is selectively secured to the top loop, the side loop or the bottom loop.

The restraining piece is fixedly secured to the top section of the cylinder. The protrusion is disposed on the inner surface of the restraining piece proximate the upper terminus, and the relieved area extends downwardly away from the upper terminus of the top cap. Alternately, the restraining piece has a plurality of protrusions. The top cap is selectively secured to the restraining piece, the top cap being dimensioned to fit around the outer surface of the restraining piece. A tether is secured to the restraining loop and the cap loop.

The bottom piece is fixedly secured to the bottom section of the cylinder. The side loop is disposed on the side wall, and the bottom loop and the aperture are disposed on the bottom surface.

In use, a golf ball is placed into the storing and transporting apparatus by forcing the golf ball into the cylinder past the protrusions on the restraining piece. In a preferred embodiment, when the spring is uncompressed, the upper spring section extends toward the restraining piece, thus forcing any golf balls in the apparatus towards the top section of the cylinder. After at least one golf ball is placed in the cylinder, then the top cap is secured to the restraining piece, the golf ball thereby being enclosed in the storing and transporting apparatus. The storing and transporting apparatus can be carried via the strap.

In an alternate embodiment of the storing and transporting apparatus, the tether is directly and fixedly secured to the restraining piece and the top cap. In a further alternate embodiment of the storing and transporting apparatus, the exterior of the cylinder is made of an insulating material and the inside diameter of the cylinder is dimensioned to receive soda cans. Further, the side wall, bottom surface, restraining piece and top cap are also made of an insulating material. In this alternate embodiment, the storing and transporting apparatus does not comprise a spring. However, it will be recognized that in a further alternate embodiment, the storing and transporting cylinder may have a spring. A soda can is placed into the storing and transporting apparatus via forcing the soda can past the protrusions on the restraining piece into the cylinder.

Accordingly, a feature and advantage of the present invention is its ability to store multiple soda cans or balls, particularly golf balls.

Another feature and advantage of the present invention is its ability to allow for a plurality of golf balls or soda cans to be easily transported.

Still another feature and advantage of the present invention is its ability to allow for the easy removal of an object being stored within.

Yet another feature and advantage of the present invention is its ability to allow for excess liquids contained therein to drain out via apertures.

Yet still another feature and advantage of the present invention is its ability to store soda cans in a temperature controlled climate.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a cross-sectional side view of an apparatus for storing, transporting and dispensing objects according to a preferred embodiment;

FIG. 2 is a detail cross-sectional side view of a top portion of the apparatus of FIG. 1, depicting a restraining piece and a top cap;

FIG. 3 is a perspective view of a bottom piece of the apparatus of FIG. 1;

FIG. 4 is a perspective view of a top piece and top cap of an apparatus for storing, transporting and dispensing objects, according to an alternate embodiment; and

FIG. 5 is a side view of an apparatus for storing, transporting and dispensing objects according to an alternate embodiment.

### DETAILED DESCRIPTION OF THE PREFERRED AND SELECTED ALTERNATE EMBODIMENTS OF THE INVENTION

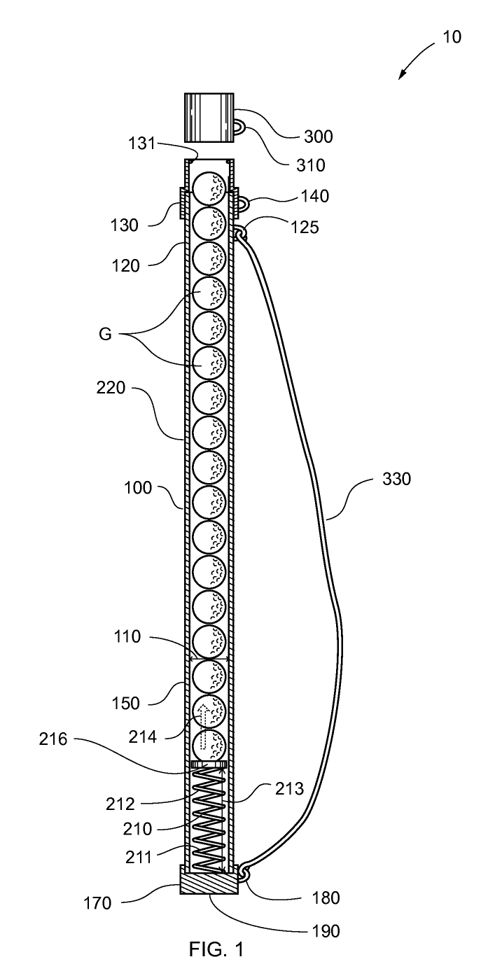

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

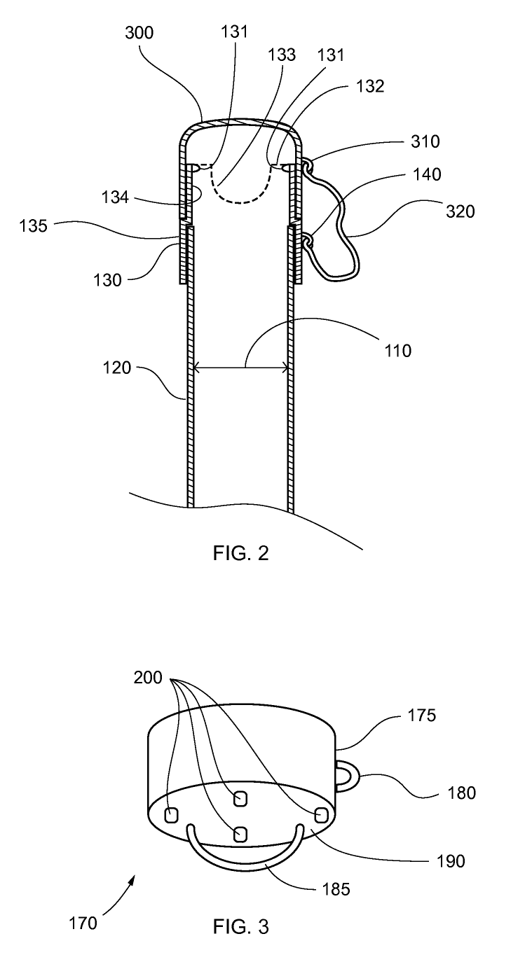

Referring now to FIGS. 1-3, the present invention in a preferred embodiment is storing and transporting apparatus 10, wherein storing and transporting apparatus 10 preferably comprises restraining piece 130, bottom piece 170, spring 210, platform 216, top cap 300, tether 320 (best shown in FIG. 2), strap 330 and cylinder 100, wherein cylinder 100 comprises inside diameter 110, exterior 220, top section 120 and bottom section 150, and wherein top section 120 comprises top loop 125, and wherein spring 210 comprises lower spring section 211, upper spring section 212 and spring length 213, and wherein spring 210 produces force 214.

Turning now more particularly to FIGS. 1 and 3, in a preferred embodiment bottom piece 170 comprises side wall 175, side loop 180, bottom loop 185, bottom surface 190 and apertures 200. Side loop 180 is disposed on side wall 175, and bottom loop 185 and apertures 200 are disposed on bottom surface 190, wherein bottom loop 185 extends outwardly away from bottom surface 190, and wherein bottom loop 185 limits or prevents apertures 200 from being obscured by a ground surface when bottom surface 190 is placed on the ground.

Turning now to FIG. 2, in a preferred embodiment, restraining piece 130 comprises restraining loop 140, protrusions 131, upper terminus 132, relieved area 133, inner surface 134 and outer surface 135, and top cap 300 comprises cap loop 310, wherein protrusions 131 comprise individual protrusions 131 disposed on inner surface 134. It will be recognized by those skilled in the art that protrusions 131 could comprise a continuous circular protrusion 131 disposed on inner surface 134 (not shown).

Referring back to FIG. 1, in a preferred embodiment, spring 210 is a resilient metal coil that is compressible. However, it will be recognized by those skilled in the art that spring 210 may comprise any compressible material that will provide force 214 when compressed. In a preferred embodiment top cap 300 comprises a polymeric material. However, it will be recognized by those skilled in the art that top cap 300 may comprise any sufficiently rigid material.

In a preferred embodiment, bottom piece 170 is fixedly secured to bottom section 150 of cylinder 100, and lower spring section 211 of spring 210 is secured to bottom section 150. Spring length 213 of spring 210 extends between lower spring section 211 and upper spring section 212. Upper spring section 212 is secured to platform 216, and when spring 210 is compressed, spring 210 exerts force 214 along spring length 213 urging platform 216 in the direction of top section 120. Platform 216 is approximately dimensioned to inside diameter 110 of cylinder 100. In an alternate embodiment, lower spring section 211 of spring 210 is not secured to bottom section 150.

In a preferred embodiment strap 330 is secured to top loop 125 and side loop 180 (best shown in FIG. 1). Alternatively, strap 330 is secured to top loop 125 and bottom loop 185. In another alternate embodiment, strap 330 is selectively secured to at least one of top loop 125, restraining loop 140, side loop 180 and bottom loop 185.

Turning now to FIGS. 1-2, restraining piece 130 is fixedly secured to top section 120 of cylinder 100. Protrusions 131 are disposed on inner surface 134 of restraining piece 130, and relieved area 133 extends downwardly away from upper terminus 132 of top cap 130. Tether 320 is secured to restraining piece 130 via restraining loop 140 and to top cap 300 via cap loop 310.

Turning now to FIGS. 1 and 3, bottom piece 170 is fixedly secured to bottom section 150 of cylinder 100.

Referring back to FIGS. 1 and 2, in use, golf ball G is placed into storing and transporting apparatus 10 by forcing golf ball G past protrusions 131 into cylinder 100. In a preferred embodiment, when spring 210 is uncompressed then upper spring section 212 extends proximate to restraining piece 130. Top cap 300 is selectively secured to restraining piece 130, wherein golf ball G is enclosed in storing and transporting apparatus 10. Storing and transporting apparatus 10 is subsequently transported via strap 330. To dispense golf ball G from storing and transporting apparatus 10, top cap 300 is removed from restraining piece 130 and subsequently golf ball G can be secured by pinching golf ball G via relieved area 133. Alternatively, golf ball G can be secured by pinching top cap 300, wherein top cap 300 is sufficiently flexible to be effectively deformed, and wherein top cap 300 is forced into contact with golf ball G via relieved area and, subsequently, when top cap 300 is removed, golf ball G is forced past protrusions 131 out of cylinder 100.

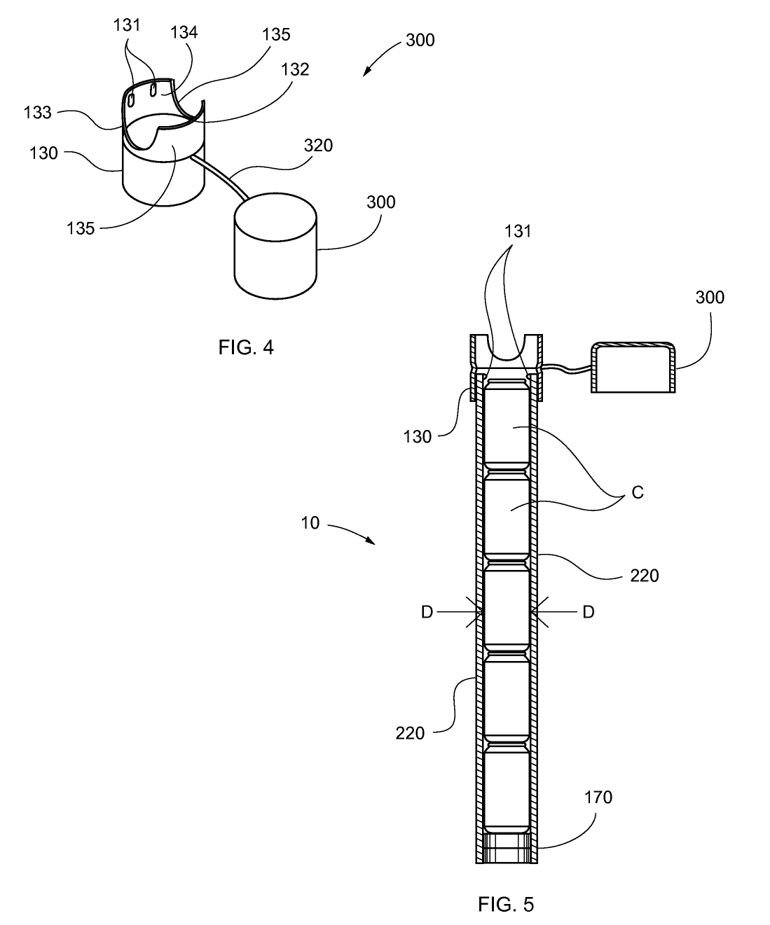

Referring now more specifically to FIG. 4, illustrated therein is an alternate embodiment of apparatus 10, wherein the alternate embodiment of FIG. 4 is substantially equivalent in form and function to that of the preferred embodiment detailed and illustrated in FIGS. 1-3 except as hereinafter described. Illustrated in FIG. 4 is an alternate embodiment of top cap 300 of storing and transporting apparatus 10 (best shown in FIG. 1), wherein the alternate embodiment of storing and transporting apparatus 10 comprises to principal components of apparatus 10, namely, restraining piece 130, bottom piece 170, spring 210, platform 216, top cap 300, tether 320, strap 330 and cylinder 100, wherein cylinder 100 comprises inside diameter 110, exterior 220, top section 120 and bottom section 150, and wherein top section 120 comprises top loop 125, and wherein spring 210 comprises lower spring section 211, upper spring section 212 and spring length 213, and wherein spring 210 produces force 214 (best shown in FIG. 1).

Bottom piece 170 comprises side wall 175, side loop 180, bottom loop 185, bottom surface 190 and apertures 200, and restraining piece 130 comprises upper terminus 132, relieved area 133, inner surface 134, outer surface 135 and a plurality of protrusions 131. In this alternate embodiment, in lieu of restraining piece 130 comprising restraining loop 140 and top cap 300 comprising cap loop 310, tether 320 is fixedly and directly secured to restraining piece 130 and tether 320 is fixedly and directly secured to top cap 300. It will be recognized by those skilled in the art that, alternatively, protrusions 131 may comprise a single continuous protrusion on inner surface 134.

Referring now more specifically to FIG. 5, illustrated therein is an alternate embodiment of apparatus 10, wherein the alternate embodiment of FIG. 5 is substantially equivalent in form and function to that of the preferred embodiment detailed and illustrated in FIGS. 1-3 except as hereinafter specifically referenced. Specifically, in the alternate embodiment of FIG. 5, exterior 220 of cylinder 100 comprises a thermally insulating material and inside diameter 110 of cylinder 100 is approximately equal to the external diameter of soda can G. Further, in the alternate embodiment of FIG. 5, storing and transporting apparatus 10 may optionally comprise spring 210.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An apparatus for storing, transporting and dispensing items, said apparatus comprising:
a cylindrical tube, said cylindrical tube comprising a top section and a bottom section;
a restraining piece, wherein said restraining piece is secured to said top section, and wherein said restraining piece comprises a restraining loop; and
a bottom piece, wherein said bottom piece is secured to said bottom section, and wherein said bottom piece comprises a bottom loop.

2. The apparatus of claim 1, wherein said bottom piece further comprises a bottom surface and an aperture, and wherein said bottom loop and said aperture are disposed on said bottom surface, and wherein bottom loop extends outwardly from said bottom surface, and wherein said bottom loop protects said aperture from being covered when said bottom surface is in contact with the ground.

3. The apparatus of claim 2, wherein said apparatus further comprises a top cap and a tether, and wherein said top cap comprises a cap loop, and wherein said tether is selectively secured to said restraining loop and said cap loop, and wherein said top cap is dimensioned to be selectively secured over said restraining piece.

4. The apparatus of claim 3, wherein said restraining piece further comprises at least one protrusion and an inner surface, and wherein said at least one protrusion is disposed on said inner surface.

5. The apparatus of claim 4, wherein said apparatus further comprises a strap, and wherein said top section comprises a top loop, and wherein said strap is secured to said bottom loop and said top loop.

6. The apparatus of claim 5, wherein said apparatus further comprises a spring, and wherein said spring is fixedly secured to said bottom piece, and where said spring comprises an axis, and wherein said axis is disposed parallel to said cylindrical tube.

7. The apparatus of claim 6, wherein said restraining piece comprises an upper terminus, and wherein said upper terminus comprises a relieved area, and wherein said relieved area is dimensioned to allow a user to grippingly secure an object stored in said apparatus.

8. The apparatus of claim 7, wherein said top cap comprises a flexible material, said top cap being sufficiently flexible to be deformed into said relieved area to grip an object in said apparatus.

9. The apparatus of claim 7, wherein said apparatus comprises a diameter, and wherein said diameter is approximately equal to the diameter of a golf ball.

10. The apparatus of claim 7, wherein said apparatus further comprises an outer wall, and wherein said outer wall comprises a thermally insulating material.

11. The apparatus of claim 10, wherein said top cap and said bottom piece each further comprises said thermally insulating material.

12. The apparatus of claim 11, wherein said apparatus comprises an inside diameter, and wherein said inside diameter is approximately equal to the external diameter of a soda can.

13. A method of storing, transporting and dispensing objects, said method comprising the steps of:
securing an object in a storing, transporting and dispensing apparatus, said storing, transporting and dispensing apparatus comprising a cylindrical tube, wherein said cylindrical tube comprises a top section and a bottom section, said storing and transporting apparatus further comprising a restraining piece, wherein said restraining piece is fixedly secured to said top section, and wherein said top section comprises a top loop, and wherein said storing and transporting apparatus further comprises a bottom piece, wherein said bottom piece is fixedly secured to said bottom section, and wherein said bottom piece comprises a side loop and a side wall, and wherein said side loop is disposed on said side wall.

14. The method of claim 13, said method further comprising:
securing a strap to each of said top loop and said side loop; and
transporting said storing, transporting and dispensing apparatus via said strap.

15. The method of claim 14, said method further comprising:
removing said object from said storing, transporting and dispensing apparatus, wherein said object is disposed at least partially within the restraining piece immediately before it is removed.

16. The method of claim 15, wherein said bottom piece further comprises an aperture and a bottom surface, and wherein said aperture is disposed on said bottom surface.

17. An apparatus for storing, transporting and dispensing objects, said apparatus comprising:
a cylindrical tube, said cylindrical tube comprising a top section and a bottom section;
a restraining piece, wherein said restraining piece is secured to said top section;
a tether; and
a top cap, wherein said top cap is fixedly secured to said restraining piece via said tether.

18. The apparatus of claim 17, wherein said apparatus further comprises a bottom piece, and wherein said bottom piece comprises a bottom surface and an aperture, and wherein said aperture is disposed on said bottom surface.

19. The apparatus of claim 18, wherein said restraining piece comprises a restraining protrusion, and wherein said restraining protrusion is disposed on said restraining piece.

20. The apparatus of claim 19, wherein said cylindrical tube is comprised of an insulating material, and wherein said apparatus is dimensioned to receive soda cans.
